(19) United States
(12) Patent Application Publication
(10) Pub. No.: US 2013/0289824 A1
(43) Pub. Date: Oct. 31, 2013

(54) VEHICLE TURN ASSIST SYSTEM AND METHOD

(71) Applicants: Upali Priyantha Mudalige, Oakland Twp., MI (US); Bakhtiar Brian Litkouhi, Washington, MI (US)

(72) Inventors: Upali Priyantha Mudalige, Oakland Twp., MI (US); Bakhtiar Brian Litkouhi, Washington, MI (US)

(73) Assignee: GM GLOBAL TECHNOLOGY OPERATIONS LLC, Detroit, MI (US)

(21) Appl. No.: 13/459,565

(22) Filed: Apr. 30, 2012

(51) Int. Cl. G08G 1/16; G06F 7/00; B62D 6/04

(52) U.S. Cl. 701/41; 701/301; 701/1; 701/70

(57) ABSTRACT

A turn assist system for a vehicle includes a transceiver configured to receive data corresponding to the location and motion of a nearby vehicle, a GPS receiver configured to generate location data representative of the location of the vehicle, a vehicle motion sensor configured to monitor one or more motion parameters of the vehicle, and a processor. The processor may be configured to: receive the location data and the vehicle motion data; maintain a plurality of motion paths within a database; map the location of the adjacent vehicle to one of the plurality of motion paths using the received data; and determine if the adjacent vehicle will obstruct the forward motion of the vehicle.

### TECHNICAL FIELD

The present invention relates generally to systems for enhancing vehicle awareness during a turn.

### BACKGROUND

Autonomous methods of vehicle navigation, such as various forms of active cruise control and/or lane following, may typically operate under the assumption that over the short-term, a vehicle's forward motion may generally track its prior path (i.e., its immediate history). More advanced systems may attempt to employ map databases and/or visual perception to attempt to refine the forward trajectory of the road, thus refining the predicted forward path. Such methods of path prediction currently do not account for non-linear changes in course, such as are presented with abrupt traffic shifts, right and left-hand turn lanes, and or U-style-turns across a median. In these instances, there may be a portion of the road that continues in a forward direction, which may obscure the system's ability to accurately track the vehicle and/or detect potential obstacles along a turning-path.

### SUMMARY

A turn assist system for a vehicle includes a transceiver configured to receive data corresponding to the location and motion of an adjacent vehicle, a GPS receiver configured to generate location data representative of the location of the vehicle, a vehicle motion sensor configured to monitor one or more motion parameters of the vehicle, and a processor.

In one configuration, the processor may be configured to maintain a plurality of motion paths within a database, with each of the plurality of motion paths respectively representing a potential path of a vehicle within a road; map the location of the adjacent vehicle to one of the plurality of motion paths using the data received from the adjacent vehicle; and determine if the adjacent vehicle will obstruct the forward motion of the vehicle.

The vehicle system may either generate the motion paths locally or may receive them from a central server. In a local-system, the processor may be configured to fuse the vehicle motion data with the location data to generate refined position data and generate the plurality of motion paths from the refined position data. In the case of a central server, the vehicle processor may be configured to transmit the refined position data to the central server via the transceiver, and may be configured to receive the plurality of motion paths from the central server via the transceiver. Each of the motion paths may represent historical position data that the central server has consolidated from a plurality of vehicles.

The vehicle system may further include an alert system that may alert a user if the vehicle processor determines that an adjacent vehicle will obstruct the forward motion of the vehicle. Alternatively, or in addition, the vehicle system may include a control system that is configured to control the motion of the vehicle. The vehicle processor may then be configured to decelerate the vehicle via the control system if it is determined that the adjacent vehicle will obstruct the forward motion of the vehicle.

A computerized method may include maintaining a plurality of motion paths in a database associated with a first vehicle; receiving data from a second vehicle indicative of the location of the second vehicle; mapping the location of the second vehicle to a first motion path of the plurality of maintained motion paths; and determining if the second vehicle will obstruct the forward motion of the first vehicle.

The method may further include mapping the location of the first vehicle to a second motion path of the plurality of maintained motion paths; receiving data from the second vehicle indicative of the motion of the second vehicle; sensing the motion of the first vehicle; and determining if the forward motion of the second vehicle along the first motion path obstructs the forward motion of the first vehicle along the second motion path.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a vehicle including a turn assist system.

FIG. 2 is a schematic diagram of a plurality of vehicles communicating between each other and between a plurality of road-side devices.

FIG. 3A is a first schematic diagram of a plurality of vehicle motion paths overlaid on a representation of a road.

FIG. 3B is a second schematic diagram of a plurality of vehicle motion paths overlaid on a representation of a road.

FIG. 3C is a third schematic diagram of a plurality of vehicle motion paths overlaid on a representation of a road.

FIG. 4 is a schematic flow diagram of a method of deducing if an oncoming vehicle is in the forward path of a turning vehicle.

### DETAILED DESCRIPTION

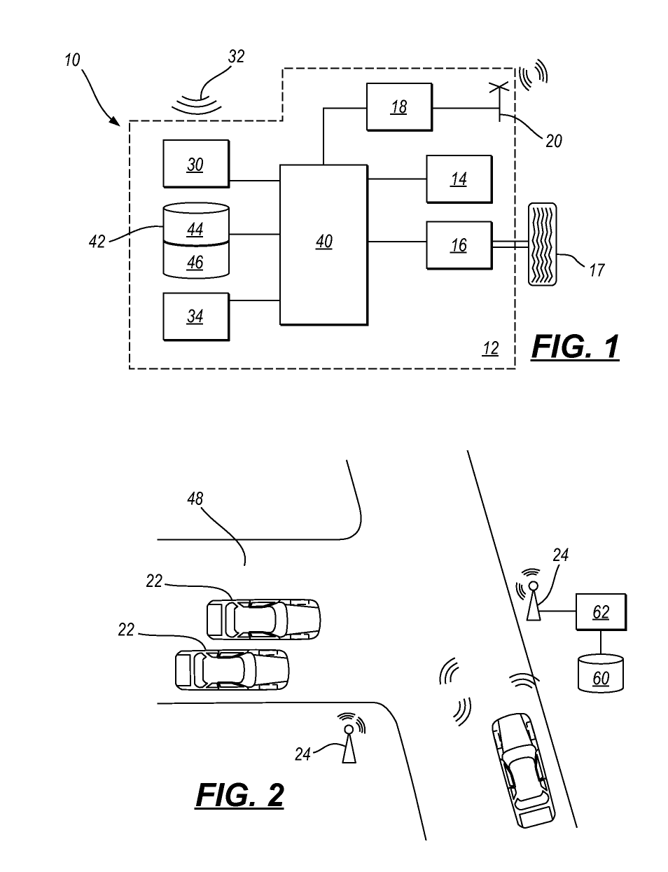

Referring to the drawings, wherein like reference numerals are used to identify like or identical components in the various views, FIG. 1 schematically illustrates a vehicle 10, such as an automobile, that includes a turn assist system 12 configured to identify the presence of an oncoming vehicle during a turning maneuver. The turn assist system 12 may include an alert system 14 that may provide a notification of the oncoming vehicle and/or may include a vehicle control system 16 configured to autonomously or semi-autonomously navigate the vehicle 10 along a prudent course by manipulating the steering angle, acceleration, and/or deceleration of one or more vehicle wheels 17.

To facilitate the system's awareness of its surroundings, the turn assist system 12 may include a transceiver 18 that may be configured to communicate with one or more adjacent vehicles 22 and/or one or more roadside devices 24 (as generally illustrated in FIG. 2). As may be appreciated, a roadside device 24 may include a beacon, a router, a switch, and/or other internet-connected devices. The transceiver 18 may be configured to transmit and receive data via the antenna 20 in a wireless manner. In one configuration, for example, the transceiver 18 may be configured to communicate using the Dedicated Short Range Communications Message Set that is specified by SAE Standard J2735. Likewise, such communications may be transmitted according to the IEEE 802.11p wireless communication standard, which specifies a manner to provide wireless communication in vehicular environments. Other message sets and/or communication protocols may be similarly used as may be appreciated by one skilled in the art.

With reference to FIG. 1 the turn assist system 12 may include a global positioning system (GPS) receiver 30 that may be configured to receive one or more GPS signals 32. From the received GPS signals 32, the GPS receiver may be configured to generate location data that may be representative of the vehicle's location according to known terrestrial coordinates (e.g., latitude, longitude, and elevation). To further refine the vehicle location, one or more on board vehicle motion sensors 34 may be employed to monitor the motion of the vehicle relative to its local environment and generate motion data corresponding to the monitored parameter. For example, the one or more vehicle motion sensors 34 may include one or more of the following: accelerometers, vehicle speed sensors, wheel speed sensors, steering angle sensors, yaw rate sensors, RADAR sensors, LIDAR sensors, lane-tracking cameras, digital maps, wireless data, GPS correction data or other similar sensors and/or signals that may be configured to monitor the heading, speed, and or position of the vehicle 10 on the road.

The transceiver 18, GPS receiver 30, vehicle sensors 34, alert system 14, and vehicle control system 16 may each be in communication with a turn assist processor 40. The turn assist processor 40 may be embodied as one or multiple digital computers or data processing devices, having one or more microprocessors or central processing units (CPU), read only memory (ROM), random access memory (RAM), electrically-erasable programmable read only memory (EEPROM), a high-speed clock, analog-to-digital (A/D) circuitry, digital-to-analog (D/A) circuitry, input/output (I/O) circuitry, power electronics/transformers, and/or signal conditioning and buffering electronics. The turn assist processor 40 may be configured to automatically perform one or more control/processing routines to provide the turn assist functionality. Each control/processing routine may be embodied as software or firmware, and may either be stored locally on the turn assist processor 40, or may be readily assessable by the turn assist processor 40.

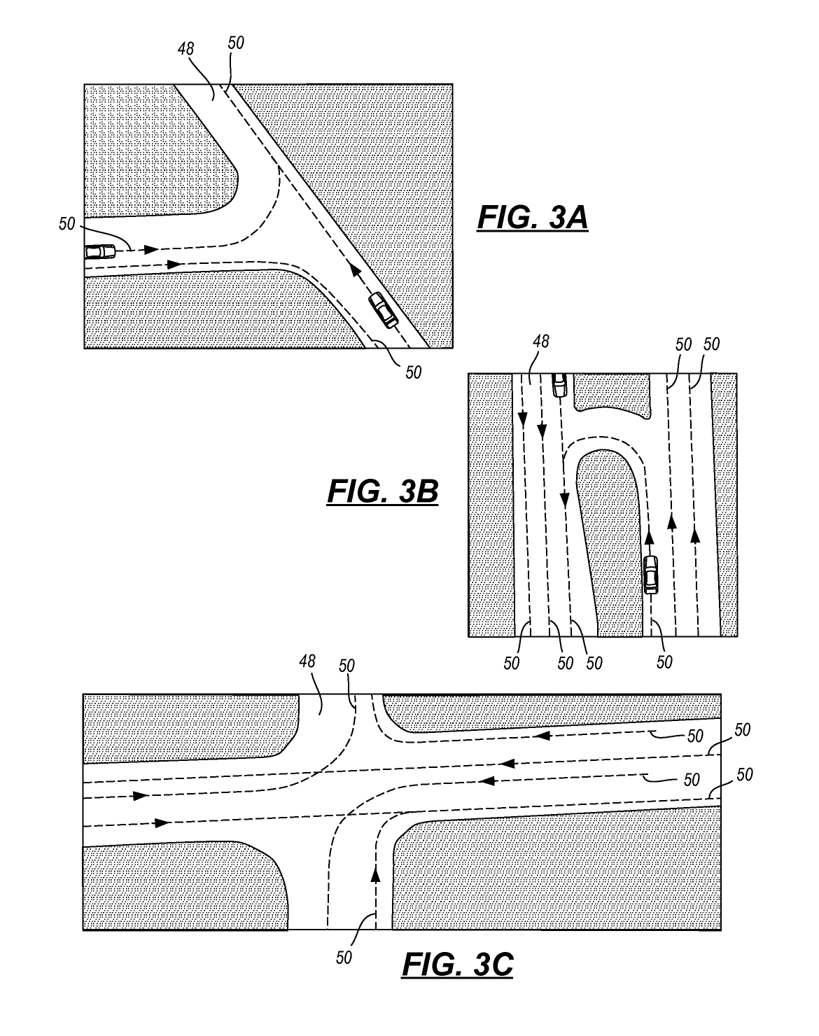

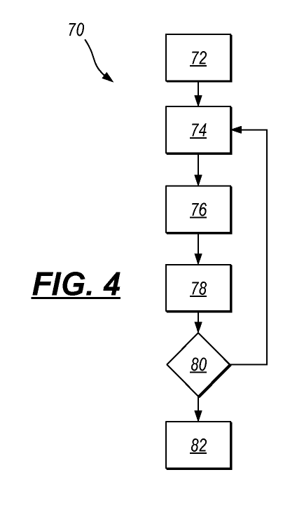

The turn assist processor 40 may be in communication with a telemetry database 42 that may include both a map database 44 and a motion path database 46. The map database 44 may include a digital representation of a road 48 being traversed by the vehicle 10. The motion path database 46 may include a plurality of motion paths 50, as generally illustrated in FIGS. 3A, 3B, and 3C that may represent likely paths of a vehicle within the road. Each motion path 50 may be empirically established using historical vehicle position data recorded either locally on the vehicle 10 or on a more global, infrastructure-level scale. Therefore, the motion paths 50 may generally be in accordance with established custom and/or traffic laws of the particular geographic locale, and, for example, may represent a particular “lane” of traffic.

To generate the motion paths 50 on a local scale, a turn assist processor 40 may receive various types/forms of vehicle location data from the GPS receiver 30 and the one or more vehicle motion sensors 34. The turn assist processor 40 may then consolidate the various forms of vehicle position data using known sensor fusion techniques, such as Kalman filtering, to produce an accurate vehicle path history within the road. While any one sensory input alone may be incapable of precisely locating the vehicle within the road (to within a preferred degree of accuracy), the combination of multiple forms of sensory input may enhance the resolution of the vehicle's path such that it may be tracked within a particular road lane. The continuous path history of the vehicle may be recorded in the telemetry database 42, and logged over an extended period of time. As the vehicle 10 may traverse the same route on one or more subsequent trips, older path history data may be updated and/or fused with newer path history data to reinforce and/or refine the potential motion path. In one configuration, the system 12 may employ a weighted average path consolidation technique that gives greater weight/preference to more recently acquired data.

When performed at an infrastructure-level, a plurality of vehicles, each equipped with the turn assist system 12, may provide path history information to a central database 60 and server 62, such as schematically illustrated in FIG. 2. The central database 60 may aggregate and refine the potential motion paths that are navigated by the various vehicles from the aggregated data. Using different techniques such as sensor fusion, the server 62 may statistically consolidate the path histories of the various vehicles into one or more common motion paths 50 (as illustrated in FIGS. 3A, 3B, and 3C). These motion paths 50 may be periodically downloaded from the server 62 to the vehicle 10 via the transceiver 18, where they may be maintained in the telemetry database 42.

FIG. 4 illustrates a method 70 that may be performed by the turn assist processor 40 to deduce whether an oncoming vehicle is in the forward path of the turning vehicle 10. The method 70 begins by maintaining a plurality of motion paths 50 in a database associated with the vehicle 10 (e.g., the telemetry database 42) (step 72). Such motion paths 50 may be either locally constructed, or downloaded from a remote server 62 on a periodic or on-demand basis.

As a vehicle 10 is traveling along a road, it may wirelessly receive location/motion data from proximate vehicles (i.e., step 74). The location/motion data may include location, speed, and heading, among others, and may be transmitted either directly via vehicle-to-vehicle, or vehicle-to-infrastructure-to-vehicle. In one configuration, the received data may be packaged in a Basic Safety Message (BSM) according to SAE Standards J2735 and J2945.

The local turn assist processor 40 may then map the received position/heading/speed of each proximate vehicle to the maintained motion paths 50 (step 76). In this manner, the processor 40 may understand the most likely forward path of each proximate vehicle based on the paths that similarly situated vehicles have taken in the past. For example, using the motion paths 50, the processor may deduce that certain proximate vehicles are in turn lanes and pose no threat, while other proximate vehicles may pose a more substantial risk.

Once each proximate vehicle is mapped to a respective motion path 50 in step 76, the processor 40 may use the received speed information to project each vehicle forward in time along its respective motion path 50 (step 78). Following this projection, the processor 40 may determine if any proximate vehicle may obstruct the forward motion of the computing vehicle 10 (step 80). Such a calculation may be a probabilistic estimate that may account for human reaction times, uncertainty in the sensory measurements, and/or expected changes in speed or path of the proximate vehicle. For example, the processor 40 may use distances measured along the motion path, together with the current vehicle speed, expected change in vehicle speed, and similar measurements from the adjacent vehicles to determine if the predicted paths of the vehicles are expected to intersect.

If the predicted paths are expected to intersect, or if an obstruction is determined, the processor 40 may perform a control action in step 82. The control action may include, for example, providing an alert to a driver of the vehicle 10 using the alert system 14, or executing a control behavior via the vehicle control system 16. As may be appreciated, the alert may be a visual, auditory, or haptic alert that may command the attention of the driver. The control behavior may include a braking action to decelerate the vehicle 10, or may include a corrective steering action, or both. In a scenario, such as illustrated in FIG. 3B, where a vehicle may be turning onto a road with multiple motion paths 50, the control system 16 may steer the vehicle onto the motion path that presents the lowest risk of an obstruction, while following the rules of traffic. Said another way, the control system may steer the vehicle on to a new motion path that is least crowded with other vehicles.

Therefore, the presently described system may determine if a moving, adjacent vehicle will obstruct its forward path merely by understanding the specific position/heading, in addition to the general kinematics or dynamics, of each vehicle on the road. The present system's use of continuously updating motion paths may provide the local vehicle with knowledge of the forward behavior of the road and/or the expected forward course of each adjacent vehicle. This understanding may be superior to the use of other sensory input, which may merely extrapolate the vehicle's path history in a forward direction (thus always presuming a relatively straight direction of travel). As described above, the maintained motion paths may accurately map the predicted path of the vehicle through traffic-pattern shifts, left or right turn lanes, and/or in U-turn-style turns across a median. As described above, such an understanding may generally be obtained through a probabilistic comparison of the current vehicle position/heading with the path that previous vehicles followed when in a similar position/heading.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. A turn assist system comprising:
a transceiver disposed on a first vehicle and configured to receive data corresponding to the location and motion of an adjacent, second vehicle;
a global positioning system receiver disposed on the first vehicle and configured to generate location data representative of the location of the first vehicle according to known terrestrial coordinates;
a vehicle motion sensor disposed on the first vehicle and configured to generate vehicle motion data corresponding to one or more motion parameters of the first vehicle;
a processor disposed on the first vehicle and in communication with the transceiver, global positioning system receiver, and vehicle motion sensor, and configured to:
receive the location data and the vehicle motion data;
maintain a plurality of motion paths within a database, each of the plurality of motion paths respectively representing a potential path of a vehicle within a road;
map the location of the second vehicle to one of the plurality of motion paths using the received data; and
determine if the second vehicle will obstruct the forward motion of the first vehicle.

2. The turn assist system of claim 1, wherein the processor is configured to fuse the vehicle motion data with the location data to generate refined position data.

3. The turn assist system of claim 2, wherein the processor is further configured to generate the plurality of motion paths from the refined position data.

4. The turn assist system of claim 3, wherein the processor is configured to transmit the refined position data to a central server via the transceiver.

5. The turn assist system of claim 4, wherein the processor is configured to receive the plurality of motion paths from the central server via the transceiver; and
wherein each of the plurality of motion paths represents refined position data consolidated from a plurality of vehicles.

6. The turn assist system of claim 1, wherein the processor is further configured to perform a control action if it is determined that the second vehicle will obstruct the forward motion of the first vehicle.

7. The turn assist system of claim 6, wherein the control action includes providing an alert to a user.

8. The turn assist system of claim 6, wherein the control action includes decelerating or steering the first vehicle using a vehicle control system.

9. A computerized method comprising:
maintaining a plurality of motion paths in a database associated with a first vehicle, each of the plurality of motion paths respectively representing a potential path of a vehicle within a road;
receiving data from a second vehicle indicative of the location of the second vehicle;
mapping the location of the second vehicle to a first motion path of the plurality of maintained motion paths;
determining if the second vehicle will obstruct the forward motion of the first vehicle.

10. The computerized method of claim 9, further comprising mapping the location of the first vehicle to a second motion path of the plurality of maintained motion paths.

11. The computerized method of claim 10, further comprising:
receiving data from the second vehicle indicative of the motion of the second vehicle;
sensing the motion of the first vehicle; and
determining if the forward motion of the second vehicle along the first motion path obstructs the forward motion of the first vehicle along the second motion path.

12. The computerized method of claim 9, further comprising providing an alert if the second vehicle is determined to obstruct the forward motion of the first vehicle.

13. The computerized method of claim 9, further comprising decelerating the first vehicle if the second vehicle is determined to obstruct the forward motion of the first vehicle.

14. The computerized method of claim 9, wherein each of the plurality of maintained motion paths represent the recorded vehicle path history of one or more vehicles within a road.

15. The computerized method of claim 14, wherein each of the plurality of maintained motion paths are generated by fusing vehicle path history of one or more vehicles together.

16. The computerized method of claim 9 further comprising overlaying the plurality of motion paths onto a digital representation of a road.

17. A turn assist system comprising:
a transceiver disposed on a first vehicle and configured to receive data corresponding to the location and motion of a second vehicle;
a global positioning system receiver disposed on the first vehicle and configured to generate location data representative of the location of the first vehicle according to known terrestrial coordinates;
a vehicle motion sensor disposed on the first vehicle and configured to generate vehicle motion data corresponding to one or more motion parameters of the first vehicle;
a processor disposed on the first vehicle and in communication with the transceiver, global positioning system receiver, and vehicle motion sensor, and configured to:
maintain a plurality of motion paths in a database associated with a first vehicle, each of the plurality of motion paths respectively representing a potential path of a vehicle within a road;
receive data from the transceiver indicative of the location of the second vehicle;
map the location of the second vehicle to a first motion path of the plurality of maintained motion paths;
determine if the second vehicle will obstruct the forward motion of the first vehicle; and
provide an alert if the second vehicle is determined to obstruct the forward motion of the first vehicle.

18. The turn assist system of claim 17, wherein the processor is further configured to:
fuse the location data with the vehicle motion data to generate refined position data indicative of the location of the first vehicle within a road;
map the location of the first vehicle to a second motion path of the plurality of maintained motion paths;
receive data from the second vehicle indicative of the motion of the second vehicle; and
determine if the forward motion of the second vehicle along the first motion path obstructs the forward motion of the first vehicle along the second motion path.

19. The turn assist system of claim 18, wherein the processor is further configured to decelerate or steer the first vehicle if the second vehicle is determined to obstruct the forward motion of the first vehicle.

20. The turn assist system of claim 18, wherein the processor is further configured to steer the first vehicle into a second lane of traffic if the second vehicle is determined to obstruct the forward motion of the first vehicle in a first lane of traffic.
